(19) United States
(12) Patent Application Publication
(10) Pub. No.: US 2025/0222880 A1
(43) Pub. Date: Jul. 10, 2025

(54) VEHICLE-MOUNTED IMAGING SYSTEM

(71) Applicant: Hitachi Astemo, Ltd., Hitachinaka-shi, Ibaraki (JP)

(72) Inventors: Kota IRIE, Hitachinaka-shi, Ibaraki (JP); Takakiyo YASUKAWA, Hitachinaka-shi, Ibaraki (JP); Hirotomo SAI, Hitachinaka-shi, Ibaraki (JP); Tatsuhiko MONJI, Hitachinaka-shi, Ibaraki (JP)

(73) Assignee: Hitachi Astemo, Ltd., Hitachinaka-shi, Ibaraki (JP)

(21) Appl. No.: 18/701,903

(22) PCT Filed: Jul. 29, 2022
(86) PCT No.: PCT/JP2022/029254

§ 371 Date: Apr. 16, 2024

(30) Foreign Application Priority Data
Oct. 18, 2021 (JP) 2021-170234

(51) Int. Cl. B60R 11/04; B60R 11/00; G01C 3/18; G03B 17/55

(52) U.S. Cl. CPC B60R 11/04; G01C 3/18; G03B 17/55; B60R 2011/0005; B60Y 2200/12; B60Y 2200/141

(57) ABSTRACT

To provide a vehicle-mounted imaging system to be installed in a vehicle, in which the vehicle-mounted imaging system makes it possible to simultaneously achieve downsizing, weight reduction, cost reduction, and scalability (versatility). The vehicle-mounted imaging system to be installed in a vehicle is characterized: by being provided with a first camera, a second camera installed at a different location than the first camera, and an image processing unit for processing images acquired by the first camera and the second camera; and in that the first camera and the second camera are connected by a first communication line, and the second camera and the image processing unit are connected by a second communication line.

### TECHNICAL FIELD

The present invention relates to a configuration of an imaging system to be installed in a vehicle, and relates specifically to a technology effective in being applied to a stereo camera forming a parallax image using multiple cameras and measuring the distance.

### BACKGROUND ART

In order to prevent a traffic accident in advance, introduction of ADAS (Advanced Driver Assistance Systems) for an automobile and a motorcycle is in progress. For example, ADAS performs monitoring and vehicle recognition around the vehicle utilizing a vehicle-mounted camera, and is utilized for attention awakening (alert), collision avoidance, and so on.

With respect to a vehicle-mounted camera used for ADAS, there is used a stereo camera simultaneously imaging an object from different directions by multiple (two in general) cameras and thereby being capable of recording information of the depth direction. By stereoscopic vision processing of an image imaged by plural cameras, the size, position, and velocity of plural solid objects can be also detected.

ADAS is divided into a system for a high class vehicle kind and a system for a normal class vehicle kind, and a design taking scalability (versatility) into consideration is required for the vehicle-mounted camera.

Also, with respect to the vehicle-mounted camera, development of a sensing system aiming improvement of the function and redundancy has been in process by adding one set of camera to a sensing system according to a prior art where a monocular camera is disposed in the back side and the like of a room mirror.

As a background art of the present technical field, there is a technology as Patent Literature 1 for example. In Patent Literature 1 there is disclosed “an information processing device assisting a user to obtain an image suitable to an imaging command for an object performed at an optional timing using a camera disposed in a mobile object”.

Also, in Patent Literature 2, there is disclosed “a travel environment detection device for a vehicle capable of accurately detecting an object present not only in the front but also in the left and right of the front of a vehicle and calculating distance information required for travel control”.

Also, in Patent Literature 3, there is disclosed “an image display system capable of improving safety in driving”.

Also, in Patent Literature 4, there is disclosed “an imaging control device capable of highly accurately achieving distance measurement by a set of camera arranged in the vertical direction”.

### CITATION LIST

### Patent Literature

Patent Literature 1: Japanese Unexamined Patent Application Publication No. 2020-106890

Patent Literature 2: Japanese Unexamined Patent Application Publication No. 2020-51942

Patent Literature 3: Japanese Unexamined Patent Application Publication No. 2013-62657

Patent Literature 4: International Publication No. WO2018/180579

### SUMMARY OF INVENTION

### Technical Problem

As described above, with respect to a vehicle-mounted camera for ADAS, there are required a design taking scalability (versatility) into consideration and further improvement of the function and redundancy as a stereo camera.

However, when one set of camera is to be added simply to a monocular camera according to a prior art and to achieve a stereo view, the number of piece of the electronic control unit (ECU) and the communication line for controlling them increases and which is disadvantageous for downsizing, weight reduction, and cost reduction of the vehicle-mounted system.

Also, in order to cope with a design taking scalability (versatility) into consideration, it is desirable that an ECU controlling the vehicle-mounted camera is not specialized in a stereo camera but has a hardware configuration having versatility.

In all of Patent Literature 1 to Patent Literature 4 described above, there is no description on a concrete configuration to simultaneously achieve downsizing, weight reduction, cost reduction, and scalability (versatility) of such vehicle-mounted camera as described above.

Therefore, an object of the present invention is to provide a vehicle-mounted imaging system to be installed in a vehicle, wherein the vehicle-mounted imaging system makes it possible to simultaneously achieve downsizing, weight reduction, cost reduction, and scalability (versatility).

### Solution to Problem

In order to solve the problem described above, the present invention is a vehicle-mounted imaging system to be installed in a vehicle and is characterized: by being provided with a first camera, a second camera installed at a different location than the first camera, and an image processing unit for processing images acquired by the first camera and the second camera; and in that the first camera and the second camera are connected by a first communication line, and the second camera and the image processing unit are connected by a second communication line.

### Advantageous Effects of Invention

According to the present invention, in a vehicle-mounted imaging system to be installed in a vehicle, it is possible to simultaneously achieve downsizing, weight reduction, cost reduction, and scalability (versatility).

Objects, configurations, and effects other than the above will be apparent from the description of the following embodiments.

### BRIEF DESCRIPTION OF DRAWINGS

FIG. 1 is a drawing illustrating a vehicle and a vehicle-mounted camera related to the first embodiment of the present invention.

FIG. 2 is a drawing illustrating a vehicle-mounted imaging system related to the first embodiment of the present invention.

FIG. 3A is a drawing illustrating a vehicle and a vehicle-mounted camera related to the second embodiment of the present invention.

FIG. 3B is a drawing schematically illustrating a region where distance information is acquired by the vehicle-mounted camera.

FIG. 4 is a drawing illustrating a vehicle-mounted imaging system related to the second embodiment of the present invention.

FIG. 5 is a drawing illustrating a vehicle and a vehicle-mounted camera related to the third embodiment of the present invention.

FIG. 6 is a drawing illustrating a vehicle-mounted imaging system related to the third embodiment of the present invention.

FIG. 7 is a drawing illustrating a vehicle and a vehicle-mounted camera related to the fourth embodiment of the present invention.

FIG. 8 is a drawing illustrating a vehicle and a vehicle-mounted camera related to the fifth embodiment of the present invention.

FIG. 9 is a drawing illustrating a vehicle-mounted imaging system related to the sixth embodiment of the present invention.

FIG. 10 is a drawing illustrating a vehicle-mounted imaging system related to the sixth embodiment of the present invention.

FIG. 11A is a drawing illustrating a vehicle-mounted imaging system according to a prior art.

FIG. 11B is a drawing illustrating a vehicle-mounted imaging system according to a prior art.

### DESCRIPTION OF EMBODIMENTS

Embodiments of the present invention will be hereinafter explained using the drawings. Also, in each drawing, a same configuration will be marked with a same reference sign, and detailed explanation will be omitted with respect to a duplicated portion.

### First Embodiment

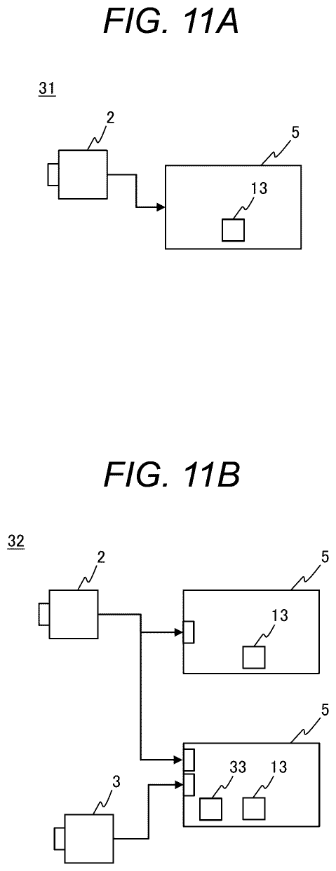

First, with reference to FIG. 11A and FIG. 11B, configurations and problems of a vehicle-mounted imaging system according to a prior art will be explained. Both of FIG. 11A and FIG. 11B are drawings illustrating a vehicle-mounted imaging system according to a prior art. FIG. 11A illustrates a monocular camera system for a normal class vehicle kind, and FIG. 11B illustrates a stereo camera system for a high class vehicle kind in which one set of camera is added to a monocular camera to obtain a stereo camera.

As illustrated in FIG. 11A, in a vehicle-mounted imaging system 31 for a normal class vehicle kind according to a prior art, a signal of an image imaged by a camera head 2 is transmitted to an image recognition ECU 5, and image processing is performed by a versatile SoC 13 installed in the image recognition ECU 5.

On the other hand, as illustrated in FIG. 11B, a vehicle-mounted imaging system 32 for a high class vehicle kind according to a prior art further adds a camera head 3 and a separate image recognition ECU 5 in addition to the configuration described above, and is configured as a stereo camera. A signal of an image imaged by the camera head 3 is transmitted to the separate image recognition ECU 5, image processing is performed by the versatile SoC 13 installed in the image recognition ECU 5, and distortion correction, brightness correction, calibration, stereo matching processing, and the like are performed by an image processing chip 33 installed in the same image recognition ECU 5.

The vehicle-mounted imaging system 32 for a high class vehicle kind according to a prior art is configured as described above, includes many image signal lines, is disadvantageous in downsizing, weight reduction, and reliability of a vehicle-mounted imaging system, and leads to cost increase also.

Also, since the image recognition ECU 5 is provided with a stereo processing function, the image recognition ECU 5 cannot be diverted to an ECU for a monocular camera and becomes an ECU with a design for exclusive use of a stereo camera.

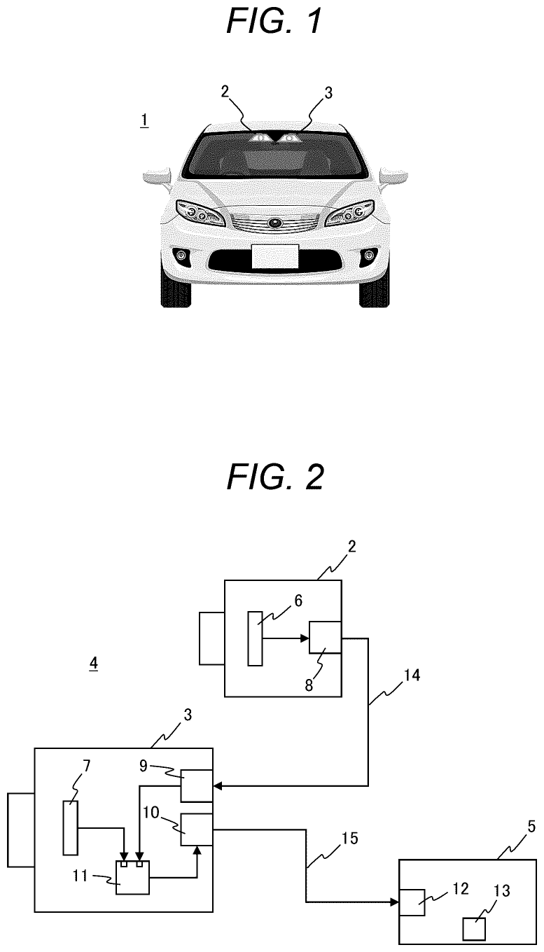

Next, with reference to FIG. 1 and FIG. 2, a vehicle-mounted imaging system related to the first embodiment of the present invention will be explained. FIG. 1 is a drawing illustrating a vehicle and a vehicle-mounted camera according to the present embodiment. FIG. 2 is a drawing illustrating a vehicle-mounted imaging system installed in a vehicle of FIG. 1.

As illustrated in FIG. 1, according to the present embodiment, two sets of camera heads 2, 3 are installed in the vicinity of a room mirror of a vehicle 1.

As illustrated in FIG. 2, a vehicle-mounted imaging system 4 installed in the vehicle 1 includes, as a main configuration, the camera head 2 (the first camera), the camera head 3 (the second camera) installed at a different location than the camera head 2, and the image recognition ECU 5 (image processing unit) for processing images acquired by the camera head 2 and the camera head 3.

The camera head 2 and the camera head 3 are connected by a communication line 14 (the first communication line), and the camera head 3 and the image recognition ECU 5 are connected by a communication line 15 (the second communication line).

The camera head 2 (the first camera) transmits an image signal of an image imaged by an imaging element 6 to the camera head 3 (the second camera) through a serializer 8 and the communication line 14 (the first communication line).

The camera head 3 (the second camera) includes an image processing chip 11 (parallax image forming unit) forming a parallax image, and the image processing chip 11 forms a parallax image using an image signal of the camera head 2 and an image signal of the camera head 3.

The camera head 3 transmits an image signal of the camera head 2 inputted through a deserializer 9, an image signal of an image imaged by an imaging element 7, and a parallax image formed by the image processing chip 11 to the image recognition ECU 5 (image processing unit) through a serializer 10 and the communication line 15 (the second communication line).

Each signal described above inputted to the image recognition ECU 5 (image processing unit) through a deserializer 12 is subjected to image processing by the versatile SoC 13.

The vehicle-mounted imaging system 4 of the present embodiment is configured as described above, and can reduce the number of piece of the image signal line and the ECU compared to the vehicle-mounted imaging system according to a prior art illustrated in FIG. 11B.

Also, since the image recognition ECU 5 is not required to have a hardware configuration specialized in a stereo camera, the image recognition ECU 5 can cope with a scalable system.

Also, the communication line 14 doubles as power supply from the camera head 3 to the camera head 2, and it is not required to separately arrange a power supply line for the camera head 2.

Also, in addition to an ISP function (Image Signal Processor) for processing an image signal, the image processing chip 11 which is a semiconductor device has a distortion correction function, a brightness correction function (calibration function), and a stereo matching processing (parallax image forming function).

### Second Embodiment

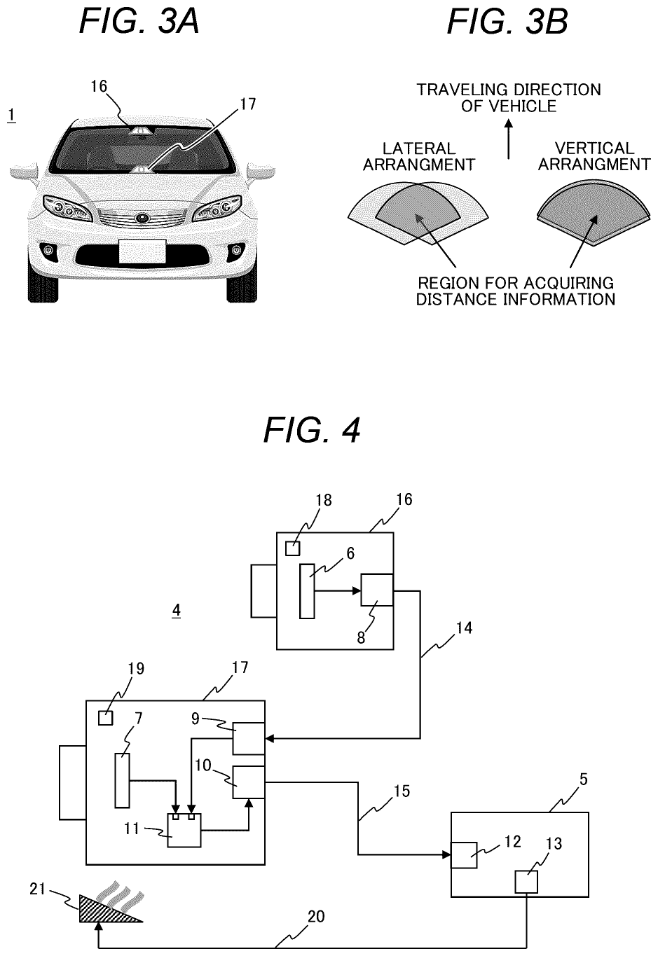

With reference to FIG. 3A to FIG. 4, a vehicle-mounted imaging system related to the second embodiment of the present invention will be explained. FIG. 3A is a drawing illustrating a vehicle and a vehicle-mounted camera of the present embodiment. FIG. 3B is a drawing schematically illustrating a region where distance information is acquired by the vehicle-mounted camera. FIG. 4 is a drawing illustrating a vehicle-mounted imaging system installed in a vehicle of FIG. 3A.

In the present embodiment, a vehicle-mounted imaging system having further higher function will be explained.

Particularly, in a system for a high class vehicle kind, there are also demands to acquire distance information of a wider range, to measure a small fallen object on a road surface and unevenness of the road surface more precisely, and to improve accuracy of the far distance.

Also, according to the vehicle-mounted imaging system explained in the first embodiment, the image processing chip 11 is installed in the camera head 3, and such possibility is also concerned that heat generation from the image processing chip 11 affects the reliability.

Therefore, according to the present embodiment, two sets of the camera head are installed in the vehicle 1 vertically as an upper camera head 16 and a lower camera head 17 as illustrated in FIG. 3A. That is to say, the lower camera head 17 is installed at a location of a different height than the upper camera head 16.

By arranging two sets of the camera head vertically as FIG. 3A, a region for acquiring the distance information can be expanded compared to the lateral arrangement explained in the first embodiment (FIG. 1) as illustrated in FIG. 3B.

Thus, the distance information is acquired in substantially all picture angle in the horizontal direction, and an object having much edge component in the lateral direction comes to be easily detected. Also, by arranging two sets of the camera head vertically, since the basic line length (the distance between two sets of the camera head) can be made long within the wiping range of the wiper, accuracy of the far distance can be improved.

Also, according to the present embodiment, as illustrated in FIG. 4, the lower camera head 17 is arranged in the vicinity of an air conditioning mechanism (defroster 21) of the vehicle 1. Also, the defroster 21 and the image recognition ECU 5 (versatile SoC 13) are connected by a communication line 20.

Also, a temperature sensor 19 is arranged in the lower camera head 17, and the air conditioning mechanism of the vehicle 1 is controlled so as to cool the lower camera head 17 by the defroster 21 when the temperature sensor 19 detects a predetermined temperature.

Also, when the air temperature drops extremely in a cold weather region and the like for example, it is also possible to secure operation of the lower camera head 17 by heating the lower camera head 17 using the defroster 21.

Further, it is also possible to arrange also a separate temperature sensor 18 different from the temperature sensor 19 in the upper camera head 16, and to control the air conditioning mechanism (defroster 21) of the vehicle 1 so that the difference between the value of the temperature sensor 18 and the value of the temperature sensor 19 falls within a predetermined range.

By suppressing heat generation of the lower camera head 17 and controlling the temperature of two sets of the camera head to be generally equal, the difference in the optical characteristic of the camera by heat can be suppressed, and deterioration of distance measurement accuracy can be suppressed.

### Third Embodiment

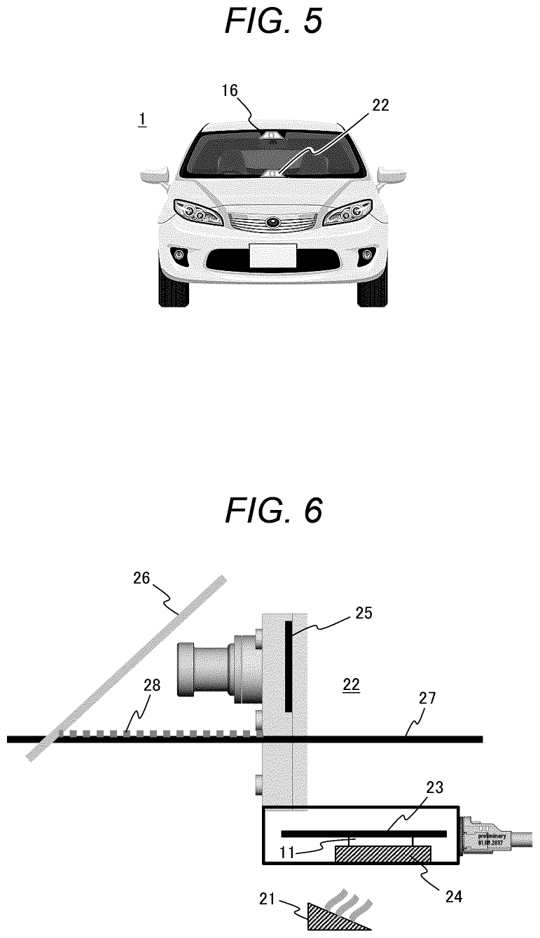

With reference to FIG. 5 and FIG. 6, a vehicle-mounted imaging system related to the third embodiment of the present invention will be explained. FIG. 5 is a drawing illustrating a vehicle and a vehicle-mounted camera of the present embodiment. FIG. 6 is a drawing illustrating a vehicle-mounted imaging system installed in a vehicle of FIG. 5.

As illustrated in FIG. 5, according to the present embodiment, two sets of the camera head are arranged vertically similarly to the second embodiment (FIG. 3A).

However, the present embodiment is different from the second embodiment (FIG. 3A) in terms that a lower camera head with built-in image processing chip 22 is provided instead of the lower camera head 17 of the second embodiment (FIG. 3A).

In FIG. 6, there is illustrated a schematic configuration of the lower camera head with built-in image processing chip 22.

The lower camera head with built-in image processing chip 22 has an L-shape construction where a camera case is divided into a sensor substrate portion including a sensor substrate 25 and a main substrate portion including a main substrate 23.

The image processing chip 11 is installed in the main substrate 23, and heat generation from the image processing chip 11 is radiated to the case through a heat spreader (radiator plate) 24. The main substrate portion is cooled by the defroster 21.

By arranging the lower camera head with built-in image processing chip 22 on a dashboard 27 in the vicinity of a windshield 26 or within the dashboard 27 as the present embodiment, cooling of the camera head where the image processing chip 11 is built-in is enabled by the air conditioning mechanism (defroster 21).

Also, by arranging the main substrate portion (the substrate where the image processing chip 11 is installed) so as to be hidden below the dashboard, the protrusion portion from the dashboard 27 can be made small. Although the case of the camera head becomes large when the image processing chip 11 is built-in in the camera head, by employing such configuration as FIG. 6, mountability of the camera head can be improved, and the field of view of a driver can be secured.

Also, by arranging a non-reflective material 28 on the dashboard 27 in the vicinity of the windshield 26, reflection of the dashboard 27 on the windshield 26 can be prevented, and a sharper image can be imaged.

### Fourth Embodiment

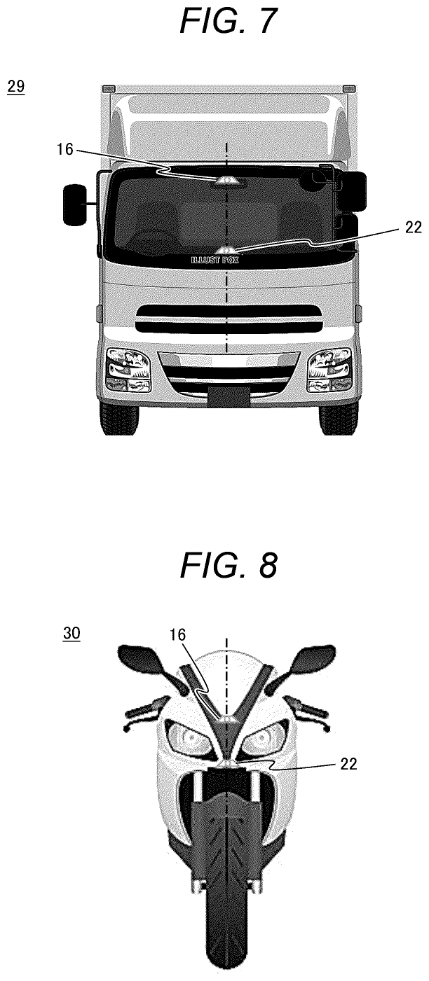

With reference to FIG. 7, a vehicle-mounted imaging system related to the fourth embodiment of the present invention will be explained. FIG. 7 is a drawing illustrating a vehicle and a vehicle-mounted camera of the present embodiment.

In the present embodiment, as a vehicle 29, an example of a truck will be explained. Also, in the present embodiment, two sets of the camera head employ vertical arrangement of the upper camera head 16 and the lower camera head with built-in image processing chip 22.

With respect to a large car such as a truck, there is room of space in a lower portion (dashboard). Therefore, it is configured that a part of the lower camera head with built-in image processing chip 22 is embedded within the dashboard as the third embodiment (FIG. 6) so as to prevent hindrance of the field of view.

Also, there is an air conditioning system for the vehicle in the dashboard. By arranging a camera head on the dashboard, the image processing chip 11 being built-in in the camera head, cooling by the air conditioning mechanism (defroster 21) is enabled.

### Fifth Embodiment

With reference to FIG. 8, a vehicle-mounted imaging system related to the fifth embodiment of the present invention will be explained. FIG. 8 is a drawing illustrating a vehicle and a vehicle-mounted camera of the present embodiment.

In the present embodiment, as a vehicle 30, an example of a motorcycle will be explained. Also, in the present embodiment, two sets of the camera head employ vertical arrangement of the upper camera head 16 and the lower camera head with built-in image processing chip 22.

The upper camera head 16 is arranged on the front surface upper side of a cowl, and the lower camera head with built-in image processing chip 22 is arranged on the front surface lower side of the cowl.

By arranging the lower camera head with built-in image processing chip 22 on the front surface lower side of the cowl, direct daylight can be avoided, and air cooling effect by the air flow in traveling can be secured easily.

### Sixth Embodiment

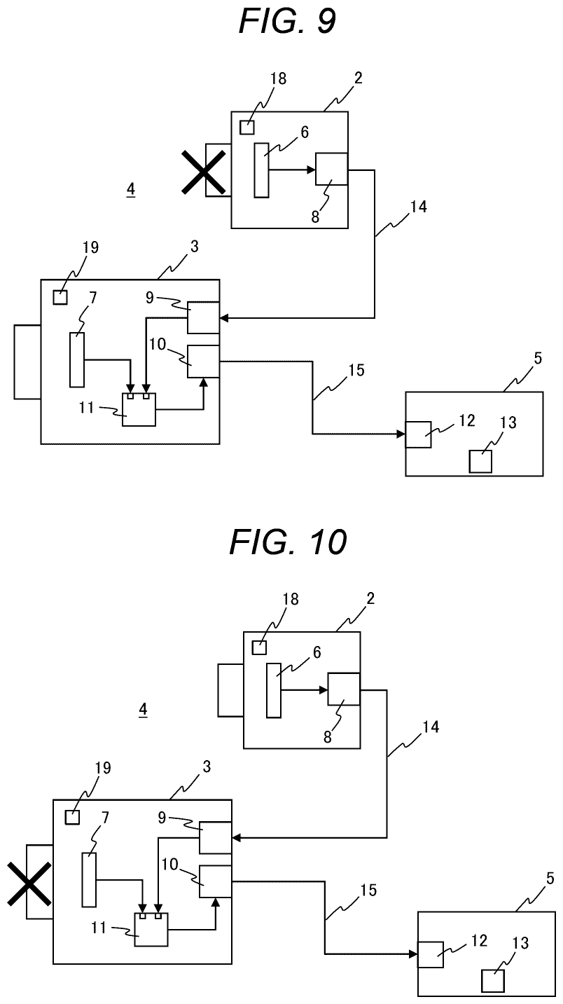

With reference to FIG. 9 and FIG. 10, a vehicle-mounted imaging system related to the sixth embodiment of the present invention will be explained. Both of FIG. 9 and FIG. 10 are drawings illustrating a vehicle-mounted imaging system of the present embodiment. FIG. 9 illustrates a state when the camera head 2 (the first camera) is in failure, and FIG. 10 illustrates a state when the camera head 3 (the second camera) is in failure.

As illustrated in FIG. 9 and FIG. 10, when either one of the camera head 2 (the first camera) and the camera head 3 (the second camera) fails, the camera head 3 (the second camera) stops formation of the parallax image by the image processing chip 11 (parallax image forming unit), and transmits an image signal of a camera having not failed to the image recognition ECU 5 (image processing unit).

With such configuration, when either one of the camera head 2 or the camera head 3 fails, the vehicle-mounted imaging system of the present embodiment can be used as such monocular camera system of a prior art as illustrated in FIG. 11A, and the vehicle-mounted camera system can have redundancy.

Also, when the common region of the imaging area of the camera head 2 (the first camera) and the camera head 3 (the second camera) is equal to a predetermined area or more, the camera head 3 (the second camera) can deem that the imaging area as a monocular camera imaged by the camera head 2 or the camera head 3 is generally equal, and therefore it may be configured that an image signal of either one of the camera head 2 or the camera head 3 is transmitted to the image recognition ECU 5 (image processing unit).

On the other hand, when the common region of the imaging area of the camera head 2 (the first camera) and the camera head 3 (the second camera) is less than a predetermined area, it can be deemed that the imaging area as a monocular camera imaged by the camera head 2 and the camera head 3 is different, and therefore image signals of both of the camera head 2 and the camera head 3 are transmitted to the image recognition ECU 5 (image processing unit).

With such configuration, when the common region of the imaging area of the camera head 2 (the first camera) and the camera head 3 (the second camera) is equal to a predetermined area or more, the processing load of the image recognition ECU 5 (image processing unit) can be lightened.

Also, the present invention is not to be limited to the embodiments described above, and various modifications are included. For example, the embodiments described above were explained in detail for easy understanding of the present invention, and are not to be necessarily limited to one including all configurations having been explained. Also, a part of a configuration of an embodiment can be substituted by a configuration of other embodiments, and a configuration of an embodiment can be added with a configuration of other embodiments. Also, with respect to a part of a configuration of each embodiment, it is possible to effect addition, deletion, and substitution of other configurations.

### REFERENCE SIGNS LIST

1, 29, 30: vehicle,
2, 3: camera head,
4, 31, 32: vehicle-mounted imaging system,
5: image recognition ECU,
6, 7: imaging element,
8, 10: serializer,
9, 12: deserializer,
11, 33: image processing chip,
13: versatile SoC,
14, 15, 20: communication line,
16: upper camera head,
17: lower camera head,
18, 19: temperature sensor,
21: defroster,
22: lower camera head with built-in image processing chip,
23: main substrate,
24: heat spreader (radiator plate),
25: sensor substrate,
26: windshield,
27: dashboard,
28: non-reflective material

1. A vehicle-mounted imaging system to be installed in a vehicle,
the vehicle-mounted imaging system comprising:
a first camera;
a second camera installed at a different location than the first camera; and
an image processing unit for processing images acquired by the first camera and the second camera, wherein
the first camera and the second camera are connected by a first communication line, and
the second camera and the image processing unit are connected by a second communication line.

2. The vehicle-mounted imaging system according to claim 1, wherein
the second camera includes a parallax image forming unit forming a parallax image,
the first camera transmits an image signal of the first camera to the second camera through the first communication line,
the parallax image forming unit forms the parallax image using an image signal of the first camera and an image signal of the second camera, and
the second camera transmits an image signal of the first camera, an image signal of the second camera, and the parallax image formed by the parallax image forming unit to the image processing unit through the second communication line.

3. The vehicle-mounted imaging system according to claim 1, wherein
the second camera is installed at a location with different height than the first camera.

4. The vehicle-mounted imaging system according to claim 1, wherein
electric power is supplied from the second camera to the first camera.

5. The vehicle-mounted imaging system according to claim 1, wherein
the second camera includes a temperature sensor, and
the second camera is cooled or heated by an air conditioning mechanism of the vehicle when the temperature sensor detects a predetermined temperature.

6. The vehicle-mounted imaging system according to claim 5, wherein
the first camera includes a temperature sensor that is different from the temperature sensor, and
the air conditioning mechanism of the vehicle is controlled so that difference between a value of a temperature sensor of the first camera and a value of a temperature sensor of the second camera falls within a predetermined range.

7. The vehicle-mounted imaging system according to claim 1, wherein
the second camera includes a semiconductor having a parallax image forming function,
stereo matching processing is performed using an image of the first camera and an image of the second camera, and
distance image including parallax information formed by the semiconductor is outputted to the image processing unit.

8. The vehicle-mounted imaging system according to claim 1, wherein
the vehicle is a passenger car or a truck, and
the second camera is installed on a dashboard or within a dashboard of the vehicle.

9. The vehicle-mounted imaging system according to claim 1, wherein
the vehicle is a motorcycle,
the first camera is installed on a front surface upper side of a cowl, and
the second camera is installed on a front surface lower side of the cowl.

10. The vehicle-mounted imaging system according to claim 2, wherein
when either one of the first camera and the second camera fails,
the second camera stops formation of a parallax image by the parallax image forming unit, and transmits an image signal of a camera having not failed to the image processing unit.

11. The vehicle-mounted imaging system according to claim 2, wherein
the second camera transmits an image signal of either one of the first camera or the second camera to the image processing unit when a common region of an imaging area of the first camera and the second camera is equal to a predetermined area or more, and
the second camera transmits image signals of both of the first camera and the second camera to the image processing unit when a common region of an imaging area of the first camera and the second camera is less than a predetermined area.
